(19) United States
(12) Patent Application Publication
(10) Pub. No.: US 2013/0315387 A1
(43) Pub. Date: Nov. 28, 2013

(54) ENCRYPTION METHOD CHARACTERIZED BY THREE DIMENSIONAL COMPUTATION, FEEDBACK CONTROL, AND DYNAMIC TRANSITION BOX

(71) Applicants: YI-LI HUANG, TAICHUNG CITY (TW); FANG-YIE LEU, TAICHUNG CITY (TW); CHUNG-CHI LIN, TAICHUNG CITY (TW)

(72) Inventors: YI-LI HUANG, TAICHUNG CITY (TW); FANG-YIE LEU, TAICHUNG CITY (TW); CHUNG-CHI LIN, TAICHUNG CITY (TW)

(21) Appl. No.: 13/481,108

(22) Filed: May 25, 2012

(51) Int. Cl. G06F 21/24

(52) U.S. Cl. 380/28

(57) ABSTRACT

An encryption method adopts an encryption principle based on sequential logic and involves performing three dimensional computation on a plaintext data unit having undergone non-linear transition through a dynamic child transition box, system keys, and dynamic feedback keys together to generate dynamic keys. After undergoing non-linear transition through different dynamic child transition boxes respectively, the dynamic keys undergo the three dimensional computation together with the system keys to generate a ciphertext data unit. Content values of the dynamic feedback keys and dynamic child transition box operating under a feedback control mechanism vary with each instance of feedback, and thus the dynamic keys and the ciphertext data are difficult to crack but effective in resisting violent attacks.

### FIELD OF TECHNOLOGY

The present invention relates to data encryption/decryption methods and principles, and more particularly, to an encryption method based on sequential logic and characterized by feedback control.

### BACKGROUND

There are two data encryption methods widely used by the industrial sector and the academic circle nowadays, namely data encryption standard (DES) and advanced encryption standard (AES). The two data encryption methods share characteristics as follows:

1. Both methods employ an encryption principle based on combinational logic, wherein an ciphertext being output is utterly determined by a plaintext being input and thus is unrelated to a plaintext previously input.

2. Both methods enable encryption of data blocks of fixed size, wherein a data block encrypted by DES contains 64 bits, and a data block encrypted by AES contains 128 bits.

3. Both methods employ an encryption principle that requires performing specific core computation repeatedly, for example, DES entails performing specific core computation 16 times, whereas AES entails performing specific core computation 10 times.

4. Both methods employ an S-Box whereby transition is performed with a fixed table in the course of encryption.

Although both DES and AES are regarded as the best data encryption methods which have ever been available, they have disadvantages as follows:

1. With the combinational logic-based encryption principle, an ciphertext being output is utterly determined by a plaintext being input, and thus the encryption principle is not effective in withstanding violent attacks, such as the known plaintext/ciphertext attack and differential attack. With DES being dedicated to 64 bit-data block encryption, it has already been cracked by the DES Cracker created by the Electronic Frontier Foundation (EFF). In view of this, AES, which is dedicated to 128 bit-data block encryption, is going to be in crack crisis too.

2. Both DES and AES encrypt data blocks of fixed size to the detriment of the flexibility of an encryption system. If the size of an encrypted data block varies flexibly, the encryption system can perform data encryption as needed more flexibly and thereby resist violent attacks and other types of attacks efficiently.

3. Both DES and AES entail performing specific core computation repeatedly. For example, DES entails performing specific core computation 16 times, whereas AES entails performing specific core computation 10 times. Although each of the instances of repeated computation is accompanied by the introduction of a new key value, repetitious computation with the same equation not only weakens security inevitably, but also reduces performance greatly.

4. Both DES and AES employ a fixed S-Box, thereby posing issues pertaining to flexibility and security. If they use a dynamic S-Box for encrypting different data, different S-Boxes with different content values can perform different non-linear transition to thereby enhance their security greatly.

### SUMMARY

The present invention provides an encryption method with a view to addressing the aforesaid four disadvantages of data encryption standard (DES) and advanced encryption standard (AES). To overcome the aforesaid first disadvantage of DES and AES, that is, the disadvantage inherent to the combinational logic-based encryption principle, the present invention adopts a sequential logic-based encryption principle that features feedback control, such that an ciphertext being output is not just determined by a plaintext being input; instead, an ciphertext being output is jointly determined by a plaintext being input and a plaintext previously input, such that not only can the ciphertext weather violent attacks efficiently, but the security of the ciphertext is enhanced greatly.

To overcome the aforesaid second disadvantage of DES and AES, that is, the disadvantage inherent to encryption of data blocks of fixed size, the present invention enables encryption of data blocks of a flexible size, such that data blocks of different sizes can be encrypted as long as data units to be encrypted by the encryption system, encryption keys, dynamic transition boxes, and the resultant ciphertext data units have the same size.

To overcome the aforesaid third disadvantage of DES and AES, that is, the disadvantage inherent to performing specific core computation repeatedly, the present invention puts forth different basic processing units for performing encryption and decryption by means of a feedback control mechanism, non-linear transition functionality of dynamic transition boxes, and three dimensional computation.

To overcome the aforesaid fourth disadvantage of DES and AES, that is, the disadvantage inherent to a fixed S-Box, the present invention involves replacing a S-Box with a mother transition box and inputting the content values of dynamic feedback keys into the mother transition box in the course of encryption/decryption so as to generate a child transition box, such that the contents of the child transition box is dynamic and thereby varies with the feedback key values as input, thereby overcoming the drawback of fixed transition boxes.

The three dimensional computation of the present invention employs three invertible operators (described later) for performing three dimensional computation on a plaintext data unit, a system key, and a dynamic feedback key in conjunction with multiple operands, such as dynamic keys, as described below.

Given a plaintext data unit p, an ciphertext data unit c, and a dynamic key K, then:

1. Exclusive OR operator: ⊕

encryption: c=p ⊕ K

decryption: p=c ⊕ K

2. Exclusive AND operator: ⊙

encryption: c=p⊙K

decryption: p=c⊙K

3. Binary adder operator: +₂

encryption: c=p+₂ K, where p and K undergo binary addition, and ignore the carry generated from the addition of the highest bit;

$$decryption \text{:} p = \{ \begin{matrix}c {-}_{2} K , & if c \geq K \\ c {+}_{2} \overline{K} {+}_{2} 1 , & if c < K ,\end{matrix}$$

where −₂ denotes binary subtraction computation, and K̅ expresses an one's complement of the key K.

According to the present invention, there are two types of the transition boxes, namely mother transition box and child transition box, and their contents, definitions, operation, and functions are described below.

If a data block to be encrypted by the encryption/decryption system contains m bits (m is a multiple of 8), then:

1. The mother transition box consists of g rows and h columns, where m=gh, 2≦g, h. Numbers 1, 2, 3, . . . , m-1, and m are rearranged randomly as a random number sequence, and then the number sequence is written to the mother transition box sequentially to become the contents of the mother transition box. Thereby there are m! candidates of the mother transition box;

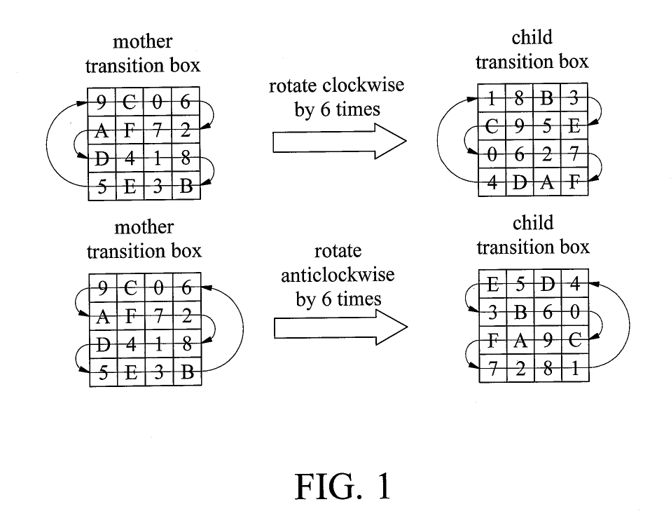

2. The child transition box is obtained by rotating the mother transition box clockwise or anticlockwise t times by one unit each, where the count variable t is a function of feedback keys. An embodiment of the 16-bit mother transition box and child transition box is illustrated with FIG. 1;

3. Encryption operation of child transition box

The encryption operation of a child transition box requires moving the content of the j^{th} bit of the plaintext data unit or dynamic key to a position specified by the content value at the j^{th} position of the child transition box, where 1≦j≦m. Upon completion of the transition of all the bits, the encryption operation of the child transition box is finished;

4. Decryption operation of child transition box

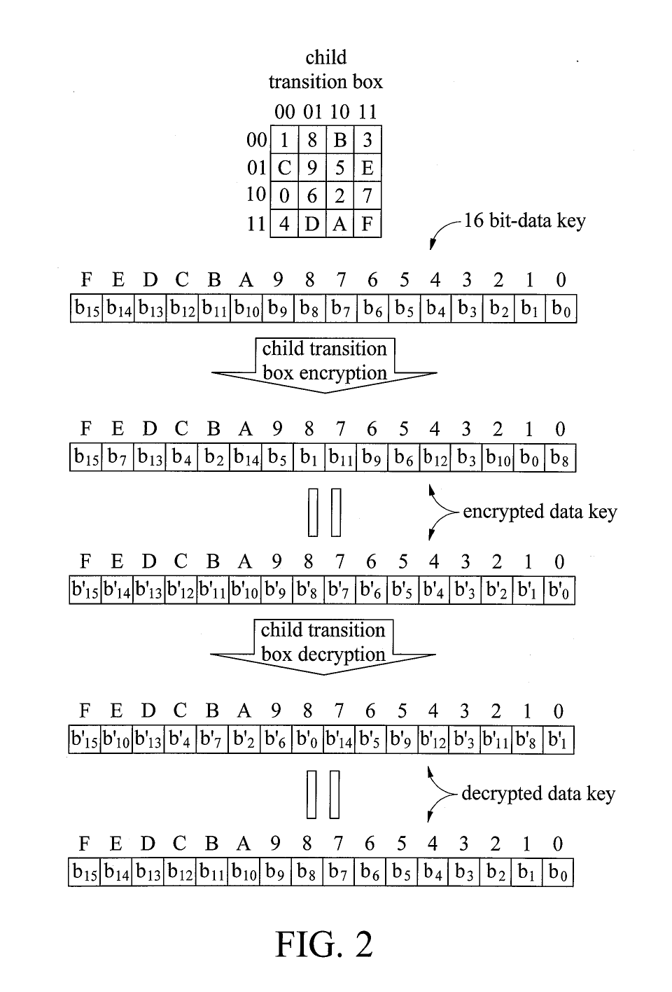

The decryption operation of a child transition box requires moving the ciphertext data unit bit at a position specified by the content value at the j^{th} position of the child transition box to the j^{th} position of the ciphertext data unit. Upon completion of the transition of all the bits, the decryption operation of the child transition box is finished. An embodiment of encryption/decryption of a data unit by the 16-bit child transition box is illustrated with FIG. 2.

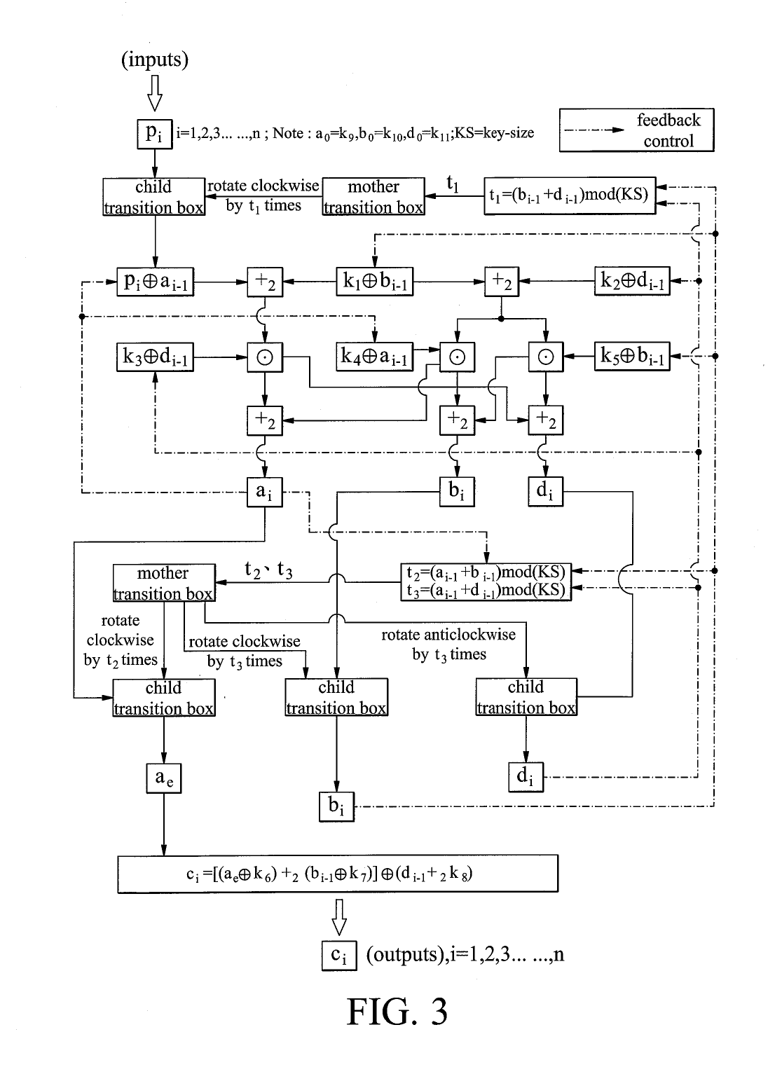

Referring to FIG. 3 which shows a flow chart of the encryption method characterized by three dimensional computation, feedback control, and dynamic transition boxes and disclosed in the present invention.

The encryption/decryption system of the present invention comprises 11 system keys K₁˜K₁₁, three dynamic feedback keys aᵢ₋₁, bᵢ₋₁, and dᵢ₋₁ , three dynamic keys aᵢ, bᵢ, and dᵢ, a mother transition box, and four dynamic child transition boxes. The initial values of the three feedback keys are a₀=K₉, b₀=K₁₀, and d₀=K₁₁. A plaintext is divided into n blocks each with a length of m bits, that is, Pla int exts=p₁p₂p₃ . . . pₙ. If the plaintext data is insufficient to fill up pₙ, then pₙ will fill any unoccupied bit with a zero. In this regard, each pᵢ, 1≦i≦n, contains m bits, and every key of the system contains m bits too, where m is a multiple of 8, such as 8, 64, 128, 256, 512, 1024, 2048 or any larger integer multiple of 8. If every key of the system contains m bits, then the mother transition box consists of g rows and h columns, where m=gh, 2≦g, h.

The content values of the three dynamic feedback keys aᵢ₋₁, bᵢ₋₁, and dᵢ₋₁ in the encryption/decryption system of the present invention are obtained by the feedback of the content values of the three dynamic keys aᵢ, bᵢ, and dᵢ, respectively, implying that the values of aᵢ, bᵢ, and dᵢ are the values of aᵢ₋₁, bᵢ₋₁, and dᵢ₋₁ in encrypting the next plaintext data unit pᵢ. In other words, the three dynamic feedback keys aᵢ₋₁, bᵢ₋₁ and dᵢ₋₁ are treated as the input values whenever the i^{th} plaintext data unit pᵢ is input; that is to say, the value of the i^{th} ciphertext key cᵢ and the value of the i^{th} dynamic keys aᵢ, bᵢ, dᵢ are jointly determined by pᵢ, aᵢ₋₁, bᵢ₋₁ and dᵢ₋₁, that is,

aᵢ=f₁(pᵢ, aᵢ₋₁, bᵢ₋₁, cᵢ₋₁, child transition box, system keys K₁˜K₁₁),

bᵢ=f₂(pᵢ, aᵢ₋₁, bᵢ₋₁, cᵢ₋₁, child transition box, system keys K₁˜K₁₁),

dᵢ=f₃(pᵢ, aᵢ₋₁, bᵢ₋₁, cᵢ₋₁, child transition box, system keys K₁˜K₁₁), and

cᵢ=f₄(pᵢ, aᵢ₋₁, bᵢ₋₁, cᵢ₋₁, child transition box, system keys K₁˜K₁₁),

where pᵢ, aᵢ₋₁, bᵢ₋₁, cᵢ₋₁ and the child transition boxes are dynamic, and system keys K₁˜K₁₁ are fixed. Most importantly, in the encryption system of the present invention, neither bᵢ, dᵢ nor the aᵢ for performing feedback plays any direct role in generating the ciphertext data unit cᵢ value. That is to say, bᵢ, dᵢ, and the aᵢ for performing feedback are dynamic parameters hidden in the system and thus invisible to crackers. Hence, crackers are unable to infer the dynamic feedback keys aᵢ₋₁, bᵢ₋₁ and dᵢ₋₁ from the dynamic keys aᵢ, bᵢ and dᵢ for performing feedback. Therefore, aᵢ₋₁, bᵢ₋₁ and dᵢ₋₁ are very secure. In conclusion, not only are the feedback dynamic keys aᵢ₋₁, bᵢ₋₁ and dᵢ₋₁ being input in every instance of encryption of the plaintext data unit pᵢ secure, but aᵢ₋₁, bᵢ₋₁ and dᵢ₋₁ are changing continuously and dynamically while the ensuing plaintext data units are being encrypted. Multiple feedback dynamic keys are hidden during the encryption processing process of the present invention, and thus the feedback control mechanism for the encryption system of the present invention is more secure than conventional feedback control mechanisms.

The encryption process of the present invention is described below.

### Encryption Process

1. (a) input the plaintext data unit pᵢ, 1≦i≦n;

(b) calculate parameter t₁=(bᵢ₋₁+dᵢ₋₁) mod KS, 1≦i≦n, where KS denotes key size;

(c) rotate the mother transition box clockwise by t₁ times to obtain the child transition box;

(d) perform the encryption operation by applying the child transition box to the plaintext data unit pᵢ to generate the encrypted parameter pᵢ;

2. denote the notations A=pᵢ ⊕ aᵢ₋₁, B=K₁ ⊕ bᵢ₋₁, C=K₂ ⊕ dᵢ₋₁, D=K₃ ⊕ dᵢ₋₁, E=K₄ ⊕ aᵢ₋₁, F=K₅ ⊕bᵢ₋₁

calculate: aᵢ=[(A+₂B)⊙D]+₂[(B+₂C)⊙E],

bᵢ=[(B+₂C)⊙E]+₂[(B+₂C)⊙F],

dᵢ=[(B+₂C)⊙F]+₂[(A+₂B)⊙D]

3. (a) calculate parameters t₂=(aᵢ₋₁+bᵢ₋₁) mod KS, t₃=(aᵢ₋₁+dᵢ₋₁) mod KS;

(b) rotate the mother transition box clockwise by t₂ times to generate the child transition box, and then perform encryption operation by applying the child transition box to the dynamic key aᵢ to generate the encryption key aₑ;

(c) rotate the mother transition box clockwise by t₃ times to generate the child transition box, and then perform encryption operation by applying the child transition box to the parameter bᵢ to generate the dynamic key bᵢ;

(d) rotate the mother transition box anticlockwise by t₃ times to generate the child transition box, and then perform encryption operation by applying the child transition box to the parameter dᵢ to generate the dynamic key dᵢ;

4. calculate cᵢ=[(aₑ ⊕K₆)+₂(bᵢ₋₁ ⊕K₇)]⊕(dᵢ₋₁+₂ K₈), 1≦i≦n, and output the ciphertext data unit cᵢ, 1≦i≦n;

The decryption process flow of the present invention is described below.

### Decryption Process

1. (a) input the ciphertext data unit cᵢ, 1≦i≦n;

(b) restore the encryption key

$${a}_{e} = \{ \begin{matrix}[ [ {c}_{i} ⊕ ( {d}_{i - 1} {+}_{2} {K}_{8} ) ] {-}_{2} ( {b}_{i - 1} ⊕ {K}_{7} ) ] ⊕ {K}_{6} , & if {c}_{i} ⊕ ( {d}_{i - 1} {+}_{2} {K}_{8} ) \geq ( {b}_{i - 1} ⊕ {K}_{7} ) \\ [ [ {c}_{i} ⊕ ( {d}_{i - 1} {+}_{2} {K}_{8} ) ] {+}_{2} ( \overline{{b}_{i - 1} ⊕ {K}_{7}} ) {+}_{2} 1 ] ⊕ {K}_{6} , & if {c}_{i} ⊕ ( {d}_{i - 1} {+}_{2} {K}_{8} ) < ( {b}_{i - 1} ⊕ {K}_{7} )\end{matrix}$$

2. (a) calculate parameter t₂=(aᵢ₋₁+bᵢ₋₁) mod KS;

(b) rotate the mother transition box clockwise by t₂ times to generate the child transition box, and then perform decryption operation by applying the child transition box to the encryption key aₑ to generate the dynamic key aᵢ;

3. denote the notations G=(B+₂ C)⊙E, H=(aᵢ−₂ G)⊙D, L=(aᵢ+₂ G̅+₂ 1)⊙D, then

(a) restore the encrypted parameter

$${p}_{i} = \{ \begin{matrix}[ [ ( {a}_{i} {-}_{2} G ) ⊙ D ] {-}_{2} B ] ⊕ {a}_{i - 1} , & if {a}_{i} \geq G and H \geq B \\ [ [ ( {a}_{i} {-}_{2} G ) ⊙ D ] {+}_{2} ( \overline{B} {+}_{2} 1 ) ] ⊕ {a}_{i - 1} , & if {a}_{i} \geq G and H < B \\ [ [ ( {a}_{i} {+}_{2} \overline{G} {+}_{2} 1 ) ⊙ D ] {-}_{2} B ] ⊕ {a}_{i - 1} , & if {a}_{i} < G and L \geq B \\ [ [ ( {a}_{i} {+}_{2} \overline{G} {+}_{2} 1 ) ⊙ D ] {+}_{2} ( \overline{B} {+}_{2} 1 ) ] ⊕ {a}_{i - 1} , & if {a}_{i} < G and L < B ;\end{matrix}$$

(b) restore parameters: bᵢ=[(B+₂ C)⊙E]+₂ [(B+₂ C)⊙F];
dᵢ=[(B+₂ C)⊙F]+₂[(A+₂ B)⊙D]

(c) calculate parameter t₃=(aᵢ₋₁+dᵢ₋₁) mod KS

(1⁰) rotate the mother transition box clockwise by t₃ times to generate the child transition box, and then perform encryption operation by applying the child transition box to parameter bᵢ to generate the dynamic key bᵢ;

(2⁰) rotate the mother transition box anticlockwise by t₃ times to generate the child transition box, and then perform encryption operation by applying the child transition box to parameter d to generate the dynamic key dᵢ;

4. (a) calculate parameter t₁=(bᵢ₋₁+dᵢ₋₁) mod KS

(b) rotate the mother transition box clockwise by t₁ times to generate the child transition box, and then perform decryption operation by applying the child transition box to the encrypted parameter pᵢ to restore plaintext data unit pᵢ, (1≦i≦n).

### BRIEF DESCRIPTION

Objectives, features, and advantages of the present invention are hereunder illustrated with specific embodiments in conjunction with the accompanying drawings, in which:

FIG. 1 illustrates an embodiment of generation of a child transition box according to the present invention;

FIG. 2 illustrates an embodiment of encryption/decryption performed on a data unit by the child transition box according to the present invention; and

FIG. 3 is a flow chart of encryption according to the present invention.

### DETAILED DESCRIPTION

Referring to FIG. 3, there is shown a flow chart of encryption according to an embodiment of the present invention. As shown in FIG. 3, an encryption/decryption system comprises 11 system keys K₁˜K₁₁, three dynamic feedback keys aᵢ₋₁, bᵢ₋₁, and dᵢ₋₁, three dynamic keys aᵢ, bᵢ, and dᵢ, a mother transition box, and four dynamic child transition boxes. The initial values of the three feedback keys are a₀=K₉, b₀=K₁₀, and d₀=K₁₁. A plaintext is divided into n blocks each of which is m bits long, that is, Pla int exts=p₁p₂p, . . . pₙ. If the plaintext data is insufficient to fill up pₙ, then pₙ will fill any unoccupied bit with a zero. In this regard, each pᵢ, 1≦i≦n, contains m bits, and every key of the system contains m bits too, where m is a multiple of 8, such as 8, 64, 128, 256, 512, 1024, 2048 or any larger integer multiple of 8. If every key of the system contains m bits, then the mother transition box consists of g rows and h columns, where m=gh, 2≦g, h.

The content values of the three dynamic feedback keys aᵢ₋₁, bᵢ₋₁, and dᵢ₋₁ in the encryption/decryption system of the present invention are obtained by the feedback of the content values of the three dynamic keys and aᵢ, bᵢ, dᵢ, respectively, implying that the values of aᵢ, bᵢ, and dᵢ are the values of aᵢ₋₁, bᵢ₋₁, and dᵢ₋₁ in encrypting the next plaintext data unit pᵢ. The three dynamic feedback keys aᵢ₋₁, bᵢ₋₁, dᵢ₋₁ and the i^{th} plaintext data unit pᵢ are input; that is to say, the value of the i^{th} ciphertext data unit cᵢ and the value of the i^{th} dynamic keys aᵢ, bᵢ, dᵢ are jointly determined by pᵢ and aᵢ₋₁, bᵢ₋₁, dᵢ₋₁, that is,

aᵢ=f₁(pᵢ, aᵢ₋₁, bᵢ₋₁, cᵢ₋₁, child transition box, system keys K₁˜K₁₁),

bᵢ=f₂(pᵢ, aᵢ₋₁, bᵢ₋₁, cᵢ₋₁, child transition box, system keys K₁˜K₁₁),

dᵢ=f₃(pᵢ, aᵢ₋₁, bᵢ₋₁, cᵢ₋₁, child transition box, system keys K₁˜K₁₁), and

cᵢ=f₄(pᵢ, aᵢ₋₁, bᵢ₋₁, cᵢ₋₁, child transition box, system keys K₁˜K₁₁),

where pᵢ, aᵢ₋₁, bᵢ₋₁, cᵢ₋₁ and the four child transition boxes are dynamic, and system keys K₁˜K₁₁ are fixed. Most importantly, in the encryption system of the present invention, neither bᵢ , dᵢ nor the aᵢ for performing feedback plays any direct role in generating the ciphertext data unit cᵢ value. That is to say, bᵢ, dᵢ , and the aᵢ for performing feedback are dynamic parameters hidden in the system and thus invisible to crackers. Therefore, it can be inferred the dynamic feedback keys aᵢ₋₁, bᵢ₋₁ and dᵢ₋₁ from the dynamic keys aᵢ, bᵢ and dᵢ for performing feedback are very secure. In conclusion, not only are the feedback dynamic keys aᵢ₋₁, bᵢ₋₁ and dᵢ₋₁ being input in every instance of encryption of the plaintext data unit pᵢ secure, but aᵢ₋₁, bᵢ₋₁ and dᵢ₋₁ are changing continuously and dynamically while the ensuing plaintext data times are being encrypted. Multiple feedback dynamic keys are hidden during the encryption processing process of the present invention, and thus the feedback control mechanism for the encryption system of the present invention is more secure than conventional feedback control mechanisms.

An embodiment of the encryption process of the present invention is described below.

### Encryption Process

1. (a) input the plaintext data unit pᵢ, 1≦i≦n;

(b) calculate parameter t₁=(bᵢ₋₁+dᵢ₋₁) mod KS, 1≦i≦n, where KS denotes key size;

(c) rotate the mother transition box clockwise by t₁ times to obtain the child transition box;

(d) perform encryption operation by applying the child transition box to plaintext data unit pᵢ to generate the encrypted parameter pᵢ;

2. denote the notations A=pᵢ ⊕ a_{i 1}, B=K₁ ⊕ b_{i 1}, C=K₂ ⊕ d_{i 1}, D=K₃ ⊕d_{i 1}, E=K₄ ⊕ a_{i 1}, F=K₅ ⊕ b_{i 1} and

calculate: aᵢ=[(A+₂B)⊙D]+₂[(B+₂C)⊙E],

bᵢ=[(B+₂C)⊙E]+₂[(B+₂C)⊙F],

dᵢ=[(B+₂C)⊙F]+₂[(A+₂B)⊙D]

3. (a) calculate parameters t₂=(aᵢ₋₁+bᵢ₋₁) mod KS, t₃=(aᵢ₋₁+dᵢ₋₁) mod KS;

(b) rotate the mother transition box clockwise by t₂ times to generate the child transition box, and then perform encryption operation by applying the child transition box to dynamic key aᵢ to generate the encryption key aₑ;

(c) rotate the mother transition box clockwise by t₃ times to generate the child transition box, and then perform encryption operation by applying the child transition box to parameter bᵢ to generate the dynamic key bᵢ;

(d) rotate the mother transition box anticlockwise by t₃ times to generate the child transition box, and then perform encryption operation by applying the child transition box to parameter dᵢ to generate the dynamic key dᵢ;

4. calculate cᵢ=[(aₑ ⊕ K₆)+₂(bᵢ₋₁ ⊕ K₇)]⊕(dᵢ₋₁+₂ K₈), 1≦i≦n, and output the ciphertext data unit cᵢ;

An embodiment of the decryption process flow of the present invention is described below.

### Decryption Process

1. (a) input the ciphertext data unit cᵢ, 1≦i≦n;

(b) restore the encryption key

$${a}_{e} = \{ \begin{matrix}[ [ {c}_{i} ⊕ ( {d}_{i - 1} {+}_{2} {K}_{8} ) ] {-}_{2} ( {b}_{i - 1} ⊕ {K}_{7} ) ] ⊕ {K}_{6} , & if {c}_{i} ⊕ ( {d}_{i - 1} {+}_{2} {K}_{8} ) \geq ( {b}_{i - 1} ⊕ {K}_{7} ) \\ [ [ {c}_{i} ⊕ ( {d}_{i - 1} {+}_{2} {K}_{8} ) ] {+}_{2} ( \overline{{b}_{i - 1} ⊕ {K}_{7}} ) {+}_{2} 1 ] ⊕ {K}_{6} , & if {c}_{i} ⊕ ( {d}_{i - 1} {+}_{2} {K}_{8} ) < ( {b}_{i - 1} ⊕ {K}_{7} )\end{matrix}$$

2. (a) calculate parameter t₂=(aᵢ₋₁+bᵢ₋₁) mod KS;

(b) rotate the mother transition box clockwise by t₂ times to generate the child transition box, and then perform decryption operation by applying the child transition box to aₑ to generate the dynamic key aᵢ;

3. denote the notations G=(B+₂ C)⊙E, H=(aᵢ−₂ G)⊙D, L=(aᵢ+₂ G̅+₂ 1)⊙D, then

(a) restore encrypted parameter

$${p}_{i} = \{ \begin{matrix}[ [ ( {a}_{i} {-}_{2} G ) ⊙ D ] {-}_{2} B ] ⊕ {a}_{i - 1} , & if {a}_{i} \geq G and H \geq B \\ [ [ ( {a}_{i} {-}_{2} G ) ⊙ D ] {+}_{2} ( \overline{B} {+}_{2} 1 ) ] ⊕ {a}_{i - 1} , & if {a}_{i} \geq G and H < B \\ [ [ ( {a}_{i} {+}_{2} \overline{G} {+}_{2} 1 ) ⊙ D ] {-}_{2} B ] ⊕ {a}_{i - 1} , & if {a}_{i} < G and L \geq B \\ [ [ ( {a}_{i} {+}_{2} \overline{G} {+}_{2} 1 ) ⊙ D ] {+}_{2} ( \overline{B} {+}_{2} 1 ) ] ⊕ {a}_{i - 1} , & if {a}_{i} < G and L < B ;\end{matrix}$$

(b) restore parameters: bᵢ=[(B+₂ C)⊙E]+₂ [(B+₂ C)⊙F];
dᵢ=[(B+₂ C)⊙F]+₂ [(A+₂ B)⊙D]

(c) calculate parameter t₃=(aᵢ₋₁+dᵢ₋₁) mod KS;

(1⁰) rotate the mother transition box clockwise by t₃ times to generate the child transition box, and then perform encryption operation by applying the child transition box to parameter bᵢ to generate the dynamic key bᵢ;

(2⁰) rotate the mother transition box anticlockwise by t₃ times to generate the child transition box, and then perform encryption operation by applying the child transition box to parameter d to generate the dynamic key dᵢ;

4. (a) calculate parameter t₁=(bᵢ₋₁+dᵢ₋₁) mod KS;

(b) rotate the mother transition box clockwise by t₁ times to generate the child transition box, and then perform decryption operation by applying the child transition box to encrypted parameter pᵢ to restore data unit pᵢ, (1≦i≦n).

What is claimed is:

1. An encryption method characterized by three dimensional computation, feedback control, and dynamic transition boxes, comprising the steps of:
providing an encryption/decryption system having 11 system keys K₁˜K₁₁, three dynamic feedback keys aᵢ₋₁, bᵢ₋₁, dᵢ₋₁, three dynamic keys aᵢ, bᵢ, dᵢ, a mother transition box, four dynamic child transition boxes, and three invertible operators including an exclusive OR operator (⊕), an exclusive AND operator (⊙), and a binary adder operator (+₂);
setting three initial feedback keys to a₀=K₉, b₀=K₁₀, d₀=K₁₁; and
dividing a plaintext into n blocks each with a length of m bits, that is, Pla int exts=p₁p₂p₃ . . . pₙ,
wherein, if a plaintext data is insufficient to fill up pₙ, then pₙ fills any unoccupied bit with a zero,
wherein each pᵢ, 1≦i≦n, contains m bits, and every key of the system contains m bits too, m being a multiple of 8, such as 8, 64, 128, 256, 512, 1024, 2048 or any larger integer multiple of 8,
wherein, if every key of the system contains m bits, then the mother transition box consists of g rows and h columns, where m=gh, 2≦g, h.

2. The method of claim 1, wherein the content values of the three dynamic feedback keys aᵢ₋₁, bᵢ₋₁, and dᵢ₋₁ are obtained by feedback of the content values of the three dynamic keys aᵢ, bᵢ, and dᵢ, respectively in encrypting the next plaintext data unit pᵢ, such that the three dynamic feedback keys aᵢ₋₁, bᵢ₋₁, dᵢ₋₁=and the plaintext data unit pᵢ are input, that is to say, the value of the i^{th} ciphertext data unit cᵢ and the value of the i^{th} dynamic keys aᵢ, bᵢ, dᵢ are jointly determined by pᵢ and aᵢ₋₁, bᵢ₋₁, dᵢ₋₁, that is,
aᵢ=f₁(pᵢ, aᵢ₋₁, bᵢ₋₁, cᵢ₋₁, child transition box, system keys K₁˜K₁₁),
bᵢ=f₂(pᵢ, aᵢ₋₁, bᵢ₋₁, cᵢ₋₁, child transition box, system keys K₁˜K₁₁),
dᵢ=f₃(pᵢ, aᵢ₋₁, bᵢ₋₁, cᵢ₋₁, child transition box, system keys K₁˜K₁₁), and
cᵢ=f₄(pᵢ, aᵢ₋₁, bᵢ₋₁, cᵢ₋₁, child transition box, system keys K₁˜K₁₁).
wherein pᵢ, aᵢ₋₁, bᵢ₋₁, cᵢ₋₁ and the four child transition boxes are dynamic, and system keys K₁˜K₁₁ are fixed,
wherein aᵢ, bᵢ, and dᵢ for performing feedback do not play any role in generating the ciphertext data unit cᵢ value,
wherein aᵢ, bᵢ, and dᵢ for performing feedback are dynamic parameters hidden in the system,
wherein not only are the feedback dynamic keys aᵢ₋₁, bᵢ₋₁ and dᵢ₋₁ being input in every instance of encryption of the plaintext data unit pᵢ secure, but aᵢ₋₁, bᵢ₋₁ and dᵢ₋₁ are changing continuously and dynamically while the ensuing plaintext data units are being encrypted.

3. The method of claim 1, wherein the three dimensional computation employs three invertible operators including the exclusive OR operator (⊕), the exclusive AND operator (⊙), and the binary adder operator (+₂) for performing computation with multiple operands, namely the plaintext data unit, system keys, dynamic feedback keys, and dynamic keys, the three invertible operators being defined as follows:
given a plaintext data unit p, an ciphertext data unit c, and a dynamic key K, then:
(a) exclusive OR operator: ⊕
encryption: c=p ⊕ K
decryption: p=c ⊕ K
(b) exclusive AND operator: ⊙
encryption: c=p⊙K
decryption: p=c⊙K
(b) binary adder operator: +₂
encryption: c=p+₂ K, where the plaintext data unit p and the key K undergo binary addition, and ignore the carry generated from addition of a highest bit;
$$decryption \text{:} p = \{ \begin{matrix}c {-}_{2} K , & if c \geq K \\ c {+}_{2} \overline{K} {+}_{2} 1 , & if c < K ,\end{matrix}$$
where −₂ denotes binary subtraction computation, and K expresses an one's complement of the key K.

4. The method of claim 1, wherein there are two types of the transition boxes, namely mother transition box and child transition box, and their contents, definitions, operation, and functions are described below:
if a plaintext data unit to be encrypted/decrypted by the encryption/decryption system contains m bits (m is a multiple of 8), then:
(1) the mother transition box consists of g rows and h columns, where m=gh, 2≦g, h. Numbers 1, 2, 3, . . . , m-1, and m are rearranged randomly as a random number sequence, and then the number sequence is written to the mother transition box sequentially to become the contents of the mother transition box. Thereby there are m! candidates of the mother transition box;
(2) the child transition box is obtained by rotating the mother transition box clockwise or anticlockwise t times by one unit each, where the count variable t is a function of feedback keys;
(3) encryption operation of the child transition box:
moving the content of the j^{th} bit of the plaintext data unit or dynamic key to a position specified by the content value at the j^{th} position of the child transition box, where 1≦j≦m, wherein the encryption operation of the child transition box is finished upon completion of the transition of all the bits;
(4) decryption operation of the child transition box:
moving the ciphertext data unit bit at a position specified by the content value at the j^{th} position of the child transition box to the j^{th} position of the ciphertext data unit i.e., the reverse operation of the corresponding encryption, wherein the decryption operation of the child transition box is finished upon completion of the transition of all the bits.

5. The method of claim 1, wherein the encryption process comprises the steps of:
step 1:
(a) inputting the plaintext data unit pᵢ, 1≦i≦n;
(b) calculate parameter t₁=(bᵢ₋₁+dᵢ₋₁) mod KS, 1≦i≦n, where KS denotes key size;
(c) rotating the mother transition box clockwise by t₁ times to obtain the child transition box;
(d) performing encryption operation by applying the child transition box to the plaintext data unit pᵢ to generate the encrypted parameter pᵢ;
step 2: denote the notations A=pᵢ ⊕ aᵢ₋₁, B=K₁ ⊕ bᵢ₋₁, C=K₂ ⊕ dᵢ₋₁, D=K₃ ⊕ dᵢ₋₁, E=K₄ ⊕ aᵢ₋₁, F=K₅ ⊕ bᵢ₋₁
and calculate: aᵢ=[(A+₂B)⊙D]+₂[(B+₂C)⊙E],
bᵢ=[(B+₂C)⊙E]+₂[(B+₂C)⊙F],
dᵢ=[(B+₂C)⊙F]+₂[(A+₂B)⊙D]
step 3:
(a) calculate parameters t₂=(aᵢ₋₁+bᵢ₋₁) mod KS, t₃=(aᵢ₋₁ +dᵢ₋₁) mod KS;
(b) rotating the mother transition box clockwise by t₂ times to generate the child transition box, and then performing encryption operation by applying the child transition box to dynamic key aᵢ to generate the encryption key aₑ;
(c) rotating the mother transition box clockwise by t₃ times to generate the child transition box, and then performing encryption operation by applying the child transition box to parameter bᵢ to generate the dynamic key bᵢ;
(d) rotating the mother transition box anticlockwise by t₃ times to generate the child transition box, and then performing encryption operation by applying the child transition box to parameter dᵢ to generate the dynamic key dᵢ;
step 4:
calculate cᵢ=[(aₑ ⊕ K₆)+₂(bᵢ₋₁ ⊕ K₇)]⊕(dᵢ₋₁+₂ K₈), 1≦i≦n, outputting the ciphertext data unit cᵢ, 1≦i≦n.

6. The method of claim 1, wherein the decryption process comprises the steps of:
step 1:
(a) inputting the ciphertext data unit cᵢ, 1≦i≦n;
(b) restore the encryption key
$${a}_{e} = \{ \begin{matrix}[ [ {c}_{i} ⊕ ( {d}_{i - 1} {+}_{2} {K}_{8} ) ] {-}_{2} ( {b}_{i - 1} ⊕ {K}_{7} ) ] ⊕ {K}_{6} , & if {c}_{i} ⊕ ( {d}_{i - 1} {+}_{2} {K}_{8} ) \geq ( {b}_{i - 1} ⊕ {K}_{7} ) \\ [ [ {c}_{i} ⊕ ( {d}_{i - 1} {+}_{2} {K}_{8} ) ] {+}_{2} ( \overline{{b}_{i - 1} ⊕ {K}_{7}} ) {+}_{2} 1 ] ⊕ {K}_{6} , & if {c}_{i} ⊕ ( {d}_{i - 1} {+}_{2} {K}_{8} ) < ( {b}_{i - 1} ⊕ {K}_{7} ) ;\end{matrix}$$
step 2:
(a) calculate parameter t₂=(aᵢ₋₁+bᵢ₋₁) mod KS;
(b) rotating the mother transition box clockwise by t₂ times to generate the child transition box, and then performing decryption operation by applying the child transition box to aₑ to generate the dynamic key aᵢ;
step 3:
denote the notations G=(B+₂ C)⊙E, H=(aᵢ−₂ G)⊙D, L=(aᵢ+₂ G̅+₂ 1)⊙D, then
(a) restore the encrypted parameter
$${p}_{i} = \{ \begin{matrix}[ [ ( {a}_{i} {-}_{2} G ) ⊙ D ] {-}_{2} B ] ⊕ {a}_{i - 1} , & if {a}_{i} \geq G and H \geq B \\ [ [ ( {a}_{i} {-}_{2} G ) ⊙ D ] {+}_{2} ( \overline{B} {+}_{2} 1 ) ] ⊕ {a}_{i - 1} , & if {a}_{i} \geq G and H < B \\ [ [ ( {a}_{i} {+}_{2} \overline{G} {+}_{2} 1 ) ⊙ D ] {-}_{2} B ] ⊕ {a}_{i - 1} , & if {a}_{i} < G and L \geq B \\ [ [ ( {a}_{i} {+}_{2} \overline{G} {+}_{2} 1 ) ⊙ D ] {+}_{2} ( \overline{B} {+}_{2} 1 ) ] ⊕ {a}_{i - 1} , & if {a}_{i} < G and L < B ;\end{matrix}$$
(b) restore parameters: bᵢ=[(B+₂C)⊙E]+₂[(B+₂C)⊙F];
dᵢ=[(B+₂ C)⊙F]+₂[(A+₂ B)⊙D]
(c) calculate parameter t₃=(aᵢ₋₁+dᵢ₋₁) mod KS;
(1⁰) rotating the mother transition box clockwise by t₃ times to generate the child transition box, and then performing encryption operation by applying the child transition box to parameter bᵢ to generate the dynamic key bᵢ;
(2⁰) rotating the mother transition box anticlockwise by t₃ times to generate the child transition box, and then performing encryption operation by applying the child transition box to parameter dᵢ to generate the dynamic key dᵢ;
Step 4:
(a) calculate parameter t₁=(bᵢ₋₁+dᵢ₋₁) mod KS;
(b) rotating the mother transition box clockwise by t₁ times to generate the child transition box, and then performing decryption operation by applying the child transition box to the encrypted parameter pᵢ to restore plaintext data unit pᵢ, (1≦i≦n).
